(19) United States
(12) Patent Application Publication
(10) Pub. No.: US 2010/0027614 A1
(43) Pub. Date: Feb. 4, 2010

(54) ERROR AWARENESS AND MEANS FOR REMEDYING SAME IN VIDEO DECODING

(75) Inventors: YANBIN YU, Fremont, CA (US); LIN YANG, Fremont, CA (US); YAN ZHONG, San Jose, CA (US); SYANG-MYAU HWANG, Cupertino, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/185,567

(22) Filed: Aug. 4, 2008

(51) Int. Cl. H04N 7/12

(52) U.S. Cl. 375/240.01; 375/E07.076

(57) ABSTRACT

A DTV receiver having method using elastic decoding method is provided. The method comprises the steps of: receiving a signal for processing; decoding the signal using a source decoder; determining a portion of the signal that are problematic; and using elastic decoding to remedy the portion of the signal that are problematic.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-113.

### FIELD OF THE INVENTION

The present invention relates generally to video or audio decoding, more specifically the present invention relates to error awareness in video/audio decoding.

### BACKGROUND

Digital television (DTV) receivers can receive signal either on a fix point basis, or on a mobile basis. The DTV that receives on the mobile basis or in the wireless environment pose challenges. The challenges include that in the mobile environment, receiving conditions such as signal noise ratio (SNR) and bit error ratio (BER) fluctuate significantly. As a result, the final bit streams can be erroneous from time to time and have some obvious gaps in the seconds range (˜1 s) when the users are temporally blacked out (e.g. a mobile device in a automobile driving through a freeway underpass) even though the average signal strength and SNR are good. This is especially true in the case when interleaving memory is not really big enough to overcome the issue in single carrier communications systems in such cases as ATSC DTV signals.

Therefore, it is desirous to decode the DTV signal jointly using both channel decoding and source decoding to thereby improve the audio/video quality and enhance users' experience.

### SUMMARY OF THE INVENTION

A DTV receiver is provided such that the receiver decodes the DTV signal jointly using both channel decoding and source decoding to thereby improve the audio/video quality and enhance users experience.

A DTV receiver having method using elastic decoding method is provided. The method comprises the steps of: receiving a signal for processing; decoding the signal using a source decoder; determining a portion of the signal that are problematic; and using elastic decoding to remedy the portion of the signal that are problematic.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a receiving system in accordance with some embodiments of the invention.

FIG. 2 is an example of a remedying a set of bad data situations in accordance with some embodiments of the invention.

FIG. 2A is a first means for remedying the set of bad data situations of FIG. 2.

FIG. 2B is a second means for remedying the set of bad data situations of FIG. 2.

FIG. 2C is an example of a physical means for achieving the remedying of FIG. 2.

FIG. 3 is a in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to power estimation for uplink or downlink using at least part of decoded information for an estimation of errors in a single carrier receiver and remedying same. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of using known sequences within the guard intervals being used for power estimation for uplink or downlink using at least part of decoded information for an estimation of errors in a single carrier receiver and remedying same. The non-processor circuits may include, but are not limited to, a radio receiver, a radio transmitter, signal drivers, clock circuits, power source circuits, and user input devices. As such, these functions may be interpreted as steps of a method to power estimation for uplink or downlink using at least part of decoded information for an estimation of errors in a single carrier receiver and remedying same. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In using at least part of decoded information for an estimation of errors in a single carrier receiver (error-awareness decoding), three situations exist. They are: situation one in which the packets of the bistreams have no error or the errors are all corrected using forward error correction (FEC) of the receiver. In this case, the decoding is conducted normally in that no extra action is required. Situation two in which the signal quality is reasonably good, but some errors in the packets are not fully corrected. Typically, under situation two nine (9) errors or more occur per instance. In this case, it would be very beneficial if the positions of the error can be identified. In this case, FEC is used to predict the positions of the error. Situation three in which the signal quality is not acceptable. In this case, the packets of data will not be reliably used.

In an exemplified embodiment of the present invention, each packet has twenty-two (22) bytes of quality indication, which amounts to one-tenth ( 1/10^{th}) overhead. The following table 1 contains elements that denote a practical transport stream (TS) data format being employed.

TABLE 1

| First | | 4-187 | 188- | |
|---|---|---|---|---|
| byte | Second, third and fourth bytes | bytes | 207 | 208-228 |
| Sync | transport_error_indicator | Payloads | 20 | 22 LS |
| Byte | | of TS | Parity | proprie- |
| | | packet | bytes | tary |
| | | | | bytes for |
| | | | | ATSC |
| | | | | decoding |
| 0x47 | payload_unit_start_indicator | | | |
| | transport_priority | | | |
| | transport_scrambling_control[1:0] | | | |
| | adaptation_field_control[1:0] | | | |
| | continuity_counter[3:0] | | | |

In a device of the present invention such as a receiver, the demodulation block typically inform upon the conditions of the TS packet. For example, the Reed-Solomon (RS) decoder in a typical Advanced Television System Committe (ATSC) system has information about error correcting results to indicating the TS packets are clean or not. Some parameters like signal noise ratio (SNR) or signal strength can also be used to judge the qualities of the bitstreams and MPEG decoder can accordingly take different strategies. The decoder acts accordingly based on the qualities of the bitstream, in order to prevent the visual impairment or artifacts from happening in the final presentation or display. The decoder of the present invention is adapted to known the position or being aware of the portion of the bitstreams that are problematic. When the decoder is aware of the portion of the bitstreams that are problematic, it will not try to decode but to conceal that portion of the picture data using some other known good data in the neighborhood. For example, the decoder may abandon rather than to show a not-so-good picture. However, if the not-so-good picture is abandoned, a viewer may perceive a blank or other undesirable display. A means for remedying same is described infra.

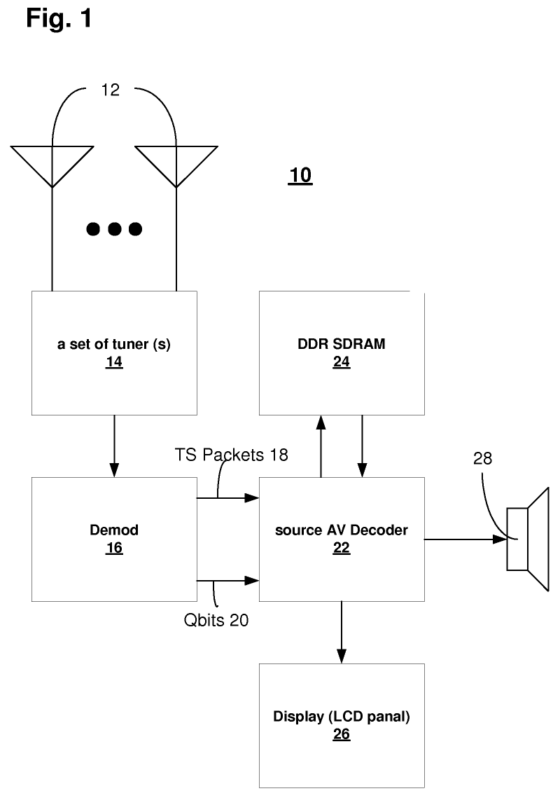

Referring to FIG. 1, a block diagram of a receiving system 10 is shown. A signal is received via a plurality of antennae 12, which is coupled to a set of tuners 14. The tuned signal is further subjected to demodulation 16 into transport stream packets 18 and quality bits 20. Transport stream packets 18 and quality bits 20 are respectively subjected to a source audio/video (AV) decoder 22 for decoding the demodulated information. AV decoder 22 is coupled to a double data rate synchronous dynamic random access memory (DDR-SDRAM) 24 for storing information including transport stream packets 18 and quality bits 20. AV decoder 22 is further coupled respectively to a display 26 such as a liquid crystal (LCD) display 26 and an audio output 28.

Another approach is to use time elastic decoding. Part of the TS can be stored in a buffer and used according to the present invention. One of the methods to overcome temporal loss of data that occurs occasionally is to have some buffer for the bitstream as well as to filter out the gaps during decoding. This becomes feasible in the situation when inexpensive SDRAM (DDR) becomes increasingly available. For example, a 256 Mbits DDR memory can easily store eight (8) seconds of data associated with HDTV bistreams, as well as the memory required to decode the HDTV signals.

Time elastic decoding may be advantageously used to decode/playback the good portion of the bitstream of DTV signals at lower speed to keep the subjective video/audio results in as good/same quality as that of the normal speed as possible. Further, for the video portion, both methods of repeat frame or the interpolation of the frames may be selectively used. For the audio portion, time stretching may be used as long as changing of the pitch does not occur.

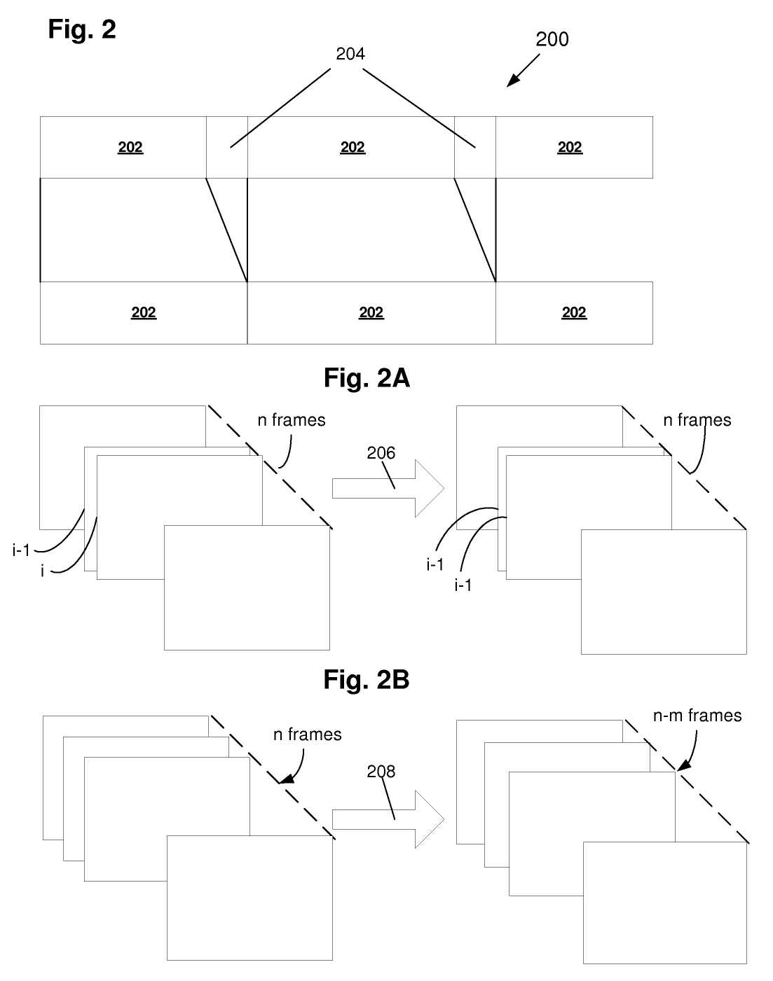

Referring to FIG. 2, a scheme 200 shows of remedying a bad data situation is shown. If some obvious gaps of bad data 204 exist, the image data in good quality 202 proximate to the gaps 204 can be used to conceal the bad data 204. Therefore, the final user's experience can be greatly improved in that no bad data 204 is finally processed subsequently or displayed.

Regarding the technical aspects of the present invention, some features are helpful. For the error-awareness decoding, one needs to let the decoder remember the positions of the bitstream that at least one Audio/Video failure occurs. Whereby the decoder can take some actions to remedy the failure. Therefore: (1) The flags (indicator bits) may be implemented throughout the decoding data chain. firmware and control logic are needed. (2) Frame Rate Conversion may be required including: When the gap in the signal quality is too big to be concealed, e.g. 1-2 second, normal audio and video data should be stretched to a slower rate without creating any noticeable artifacts. (3) Temporal Image Scaling may be required including: The images (pictures) are interpolated in time domain using motion vectors; Over-lapped (occluded) region has to be taken care of or addressed. (4) Temporal Audio Scaling may be required including: The audio can be played at a slower or faster speed without changing the associated pitch. See Table 2

TABLE 2
Options:

| Step | Name | Descriptions | Notes: |
|---|---|---|---|
| 1 | Error | The error indication is used to prevent | Some limited |
| | awareness | some artifact from happening | improvement |
| | MPEG | | in video |
| | decoding | | quality |
| 2 | Simple | The bitstream is played at a slower | Some video |
| | Elastic | speed in normal conditions and the gap | and audio |
| | Decoding | is filled using buffered bitstream. | artifacts may |
| | | No temporal scaling is performed, and | happen |
| | | simple dropping frames and repeating | |
| | | frames are used. | |

Referring to FIG. 2A, a first means 206 for remedying the set of bad data situations of FIG. 2 is shown. Bad data 204 is detected by such devices as a FEC decoder. Image data in good quality 202 proximate to bad data 204 is used instead. There is stored and available a set of n frames with n being a natural number and ranging from 1 to i to n. At least one frame includes bad data 204, which is known as to when it will occur. As a remedy, good quality 202 proximate to bad data 204 is used instead. More specifically under this circumstance, frame i-1 is used in place of frame i. Note that the total number of frames remains n frames.

Referring to FIG. 2B, a second means 208 for remedying the set of bad data situations of FIG. 2 is shown. There is stored and available a set of n frames with n being a natural number and ranging from 1 to i to n. At least one frame includes bad data 204, which is known as to when it will occur. As a remedy, good quality 202 proximate to bad data 204 is used instead. More specifically under this circumstance, m frames include bad data. Frame n-m is used in place of frame n. Note that the total number of frames is n-m frames. The n-m frames are distributed along T1, which used to accommodate n frames.

Referring to FIG. 2C is an example of a physical means 210 for achieving the remedying of FIG. 2. A buffer 210 stores at least the set of n frames for processing including the process described in FIGS. 2-2B. Buffer 210 may be part of the DDR-SDRAM 24 of FIG. 1. An incoming transport stream 212 stored data within buffer 210. The desired data or frame is used out of buffer 210 on an as needed basis from an out coming transport stream 214. Buffer 210 may be a first-in-first-out (FIFO) buffer. Further, buffer 210 may reside within a DDR memory. Still further, more than one buffer 210 may be used.

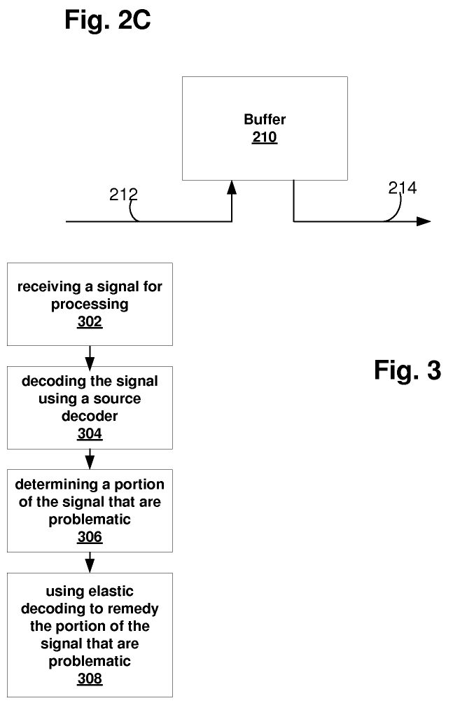

Referring to FIG. 3, a flowchart 300 for carrier to Interference-plus-Noise Ratio (CINR) estimate for downlink channel is shown. A receiver receives a signal for processing (Step 302). The receiver may be a single band receiver such as an ATSC DTV receiver. A source decoder decodes the signal (Step 304). The signal includes data of TS. Using the decoder such as a FEC decoder to determine a portion of the signal that is problematic (Step 306). This determination includes a determination of the time along a time line in which the problematic portion htat is going to be processed and shown. Use elastic decoding to remedy the portion of the signal that is problematic by using non-problematic instead of the portion of the signal that is problematic (Step 308). These remedies include that which are described in FIGS. 2A-2B.

The present invention pertains to error awareness to inform source decoder up the byte or even smaller units so that error can be avoided. Further, the present invention pertains to elastic decoding of video and audio signals so that user experience can be improved. One example in which the present invention pertains to is that when black out spots occur. Black out spots includes locations such as a freeway underpath.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method comprising the steps of:
receiving a signal for processing;
decoding the signal using a source decoder;
determining a portion of the signal that are problematic; and
using elastic decoding to remedy the portion of the signal that are problematic.

2. The method of claim 1, wherein the signal comprises bitstreams.

3. The method of claim 1, wherein the receiving step comprises using a DTV receiver for receiving A/V signals.

4. The method of claim 1, wherein the DTV receiver comprises a single band receiver.

5. The method of claim 1, wherein the elastic decoding step comprises using a buffer for storing good data proximate to bad data.

6. The method of claim 1, wherein the elastic decoding step comprises using good data proximate to bad data while maintaining frame numbers unchanged within a predetermined time segment.

7. The method of claim 1, wherein the elastic decoding step comprises deleting bad data and using good data proximate to bad data within a predetermined time segment.

8. The method of claim 1, wherein the elastic decoding step comprises playing back good data proximate to the bad data at lower speed without playing back the bad data.

9. The method of claim 1, wherein the elastic decoding step comprises playing back good data proximate to the bad data without playing back the bad data by stretching a segment of time for audio data as long as changing of pitch does not occur.

10. A receiver comprising a method including the steps of:
receiving a signal for processing;
decoding the signal using a source decoder;
determining a portion of the signal that are problematic; and
using elastic decoding to remedy the portion of the signal that are problematic.

11. The receiver of claim 10, wherein the signal comprises bitstreams.

12. The receiver of claim 10, wherein the receiving step comprises using a DTV receiver for receiving A/V signals.

13. The receiver of claim 10, wherein the DTV receiver comprises a single band receiver.

14. The receiver of claim 10, wherein the elastic decoding step comprises using a buffer for storing good data proximate to bad data.

15. The receiver of claim 10, wherein the elastic decoding step comprises using good data proximate to bad data while maintaining frame numbers unchanged within a predetermined time segment.

16. The receiver of claim 10, wherein the elastic decoding step comprises deleting bad data and using good data proximate to bad data within a predetermined time segment.

17. The receiver of claim 10, wherein the elastic decoding step comprises playing back good data proximate to the bad data at lower speed without playing back the bad data.

18. The receiver of claim 10, wherein the elastic decoding step comprises playing back good data proximate to the bad data without playing back the bad data by stretching a segment of time for audio data as long as changing of pitch does not occur.
